(19) United States
(12) Patent Application Publication
(10) Pub. No.: US 2026/0097613 A1
(43) Pub. Date: Apr. 9, 2026

(54) WHEEL UNIT WITH INSERT FOR A MOTOR VEHICLE

(71) Applicant: Continental Automotive Technologies GmbH, Hannover (DE)

(72) Inventors: Gilles CAPDEPON, Toulouse (FR); Frédéric GAUGAIN, Toulouse (FR)

(73) Assignee: Continental Automotive Technologies GmbH, Hannover (DE)

(21) Appl. No.: 19/257,797

(22) Filed: Jul. 2, 2025

(30) Foreign Application Priority Data
Jul. 18, 2024 (FR) FR2407909

(51) Int. Cl. B60C 23/04

(52) U.S. Cl. CPC B60C 23/0494

(57) ABSTRACT

A wheel unit for a motor vehicle wheel. The wheel unit includes a casing, a measuring module and a valve. The measuring module being mounted inside the casing and being configured to measure at least the air pressure inside the wheel. The casing includes an insert integrated into the front wall, the insert including two deformable curved front portions projecting from the front face of the front wall of the casing and each configured to come to bear against the rear face of the clamping ring and to become caulked by the clamping ring when the union nut is tightened against the wheel rim.

### CROSS REFERENCE TO RELATED APPLICATIONS

This application claims priority to French Application No. FR2407909, filed Jul. 18, 2024, the contents of such application being incorporated by reference herein.

### FIELD OF THE INVENTION

The present invention relates to the field of motor vehicles and more specifically relates to a wheel unit for a motor vehicle wheel and to a method for mounting such a wheel unit.

### BACKGROUND OF THE INVENTION

Nowadays, it is known practice for wheel units to be mounted in the wheels of motor vehicles to measure the pressure and temperature of the air in the wheels and, if applicable, signal to the driver a drop in pressure or an abnormal rise in temperature.

A known type of wheel unit comprises a casing, a measuring module and a valve. The measuring module is mounted inside the casing and is configured to measure the air pressure inside the wheel.

The valve comprises, in a known manner, a valve body configured to be positioned in an orifice in the wheel rim and extending between an air inlet free end fitted with a cap and a connected end.

The valve further comprises a clamping ring placed around the valve body and configured to come to bear against the interior face of the rim via its front face, compressing a seal.

The valve also includes a union nut configured to be placed around the valve body and against the exterior face of the rim in order to fix the wheel unit on the rim by cooperating via the rim with the clamping ring.

Finally, the valve comprises a valve base connected to the valve body by its connected end and extending on either side of the connected end along a longitudinal axis perpendicular to the longitudinal axis of the valve body, said valve base being mounted in a housing formed in the upper part of the casing with a clearance to pivot about the longitudinal axis of the valve base and such that the valve body extends out of the casing through an opening formed in a front wall of the casing.

With this type of wheel unit, tightening the union nut can cause the clamping ring to crush and bend the front wall of the casing, especially around the opening in which the valve body extends, and this can weaken the casing of the wheel unit, and possibly cause the wheel unit mounting of the rim to break, especially when the wheel unit is subjected to accelerations of several hundred g or to over-tightening of the union nut, thus generating measurements that may be incorrect.

The tightening of the union nut may also cause bending of the clamping ring, and this may reduce the effectiveness of the seal it compresses, or even lead to a loss of air pressure in the tire, in particular if the union nut is overtightened.

A simple, reliable and effective solution allowing these drawbacks to be at least partially rectified would therefore be advantageous.

### SUMMARY OF THE INVENTION

To this end, one aspect of the invention is firstly a wheel unit for a motor vehicle wheel, said wheel unit comprising a casing made of a plastic material, a measuring module and a valve, said measuring module being mounted inside said casing and being configured to measure at least the air pressure inside the wheel, said valve comprising:
a metal valve body configured to be positioned in an orifice in the wheel rim and extending between an air inlet free end fitted with a cap and a connected end,
a metal clamping ring placed around the valve body and configured to come to bear against the interior face of the rim via its front face, compressing a seal and comprising a rear face, opposite to the front face,
a union nut configured to be placed around the valve body and against the exterior face of the rim in order to fix the wheel unit on the rim by cooperating via the rim with the clamping ring, and
a metal valve base connected to the valve body by its connected end and extending on either side of the connected end along a longitudinal axis perpendicular to the longitudinal axis of the valve body, said valve base being mounted in a housing formed in the upper part of the casing with a clearance to pivot about the longitudinal axis of the valve base and such that the valve body extends out of the casing through an opening formed in a front wall of the casing.

The wheel unit is notable in that the casing comprises an inbuilt metal insert integrated, notably molded or overmolded, into said front wall, said insert comprising at least two curved portions projecting from the front wall and being configured to come into contact with the valve to lock said valve against the front wall while maintaining a clearance to prevent the clamping ring and/or the valve base from coming into contact with the plastic portions of the front wall.

The curved portions prevent direct compression of the casing between the clamping ring and the valve base (environmental resistance) and thus preserve the integrity of the components. This also makes it possible to reduce, or even eliminate, the risk of the casing tipping as the wheel turns.

In one embodiment, the insert comprises two deformable curved front portions projecting from the front face of the front wall of the casing and each configured to come to bear against the rear face of the clamping ring and to become caulked by said clamping ring when the union nut is tightened against the rim without the clamping ring coming into contact with the front wall of the casing.

The deformable curved front portions allow, by being caulked (i.e. crushed) by the rear face of the clamping ring during tightening, the insert of the casing to be shaped to conform to the clamping ring, and thus confer clamping that is at once firm, effective and reliable. The caulking of the curved front portions also allows the clamping ring to avoid bending and remain flat during clamping, improving clamping strength and thus allowing the seal to maintain optimum efficiency when the wheel unit is mounted on the rim, thereby preventing air from escaping and leading to a loss of pressure in the tire, especially if the union nut is overtightened. The wheel unit thus mounted is able to withstand accelerations of several hundred g without moving, thus improving the quality of the measurements.

Preferably, with the valve base having a domed front face facing the rear face of the front wall, the insert comprises two curved rear portions projecting from the rear face of the front wall of the casing and which are shaped to conform to the domed front face of the valve base in order to absorb the force applied by the valve base on the rear face of the front wall during tightening.

In one embodiment, the insert includes both two deformable curved front walls and two curved rear walls.

Advantageously, the insert is of one piece to make it easy to manufacture and to mold.

Preferably, the insert is metal, for example made of steel.

Advantageously, the insert comprises two wings connected by a connecting arm, each wing comprising a curved front portion.

Advantageously also, with the insert comprising two wings connected by a connecting arm and two curved rear portions, each wing comprises one curved rear portion.

In one embodiment, the rear face of the clamping ring is flat to allow effective caulking of the clamping ring against the curved portions of the insert during tightening, the caulking generating two flat rails that prevent the clamping ring from bending.

In one embodiment, the rear face of the clamping ring is curved.

In one embodiment, the clamping ring has a circular shape.

An aspect of the invention also relates to a method of mounting a wheel unit as described above, said method comprising the steps of:
inserting the valve body into the valve orifice in the rim,
positioning the valve by pivoting about the longitudinal axis of the valve base,
fitting the union nut around the valve body,
tightening the union nut against the front face of the rim so that the rear face of the clamping ring caulks the curved front portions of the insert.

An aspect of the invention also relates to a wheel for a motor vehicle comprising a wheel unit as described above.

An aspect of the invention also relates to a motor vehicle comprising at least one wheel as described above.

### BRIEF DESCRIPTION OF THE DRAWINGS

Other features and advantages of aspects of the invention will become more apparent upon reading the description that follows. This description is purely illustrative and is to be read with reference to the appended drawings, in which:

FIG. 1 schematically illustrates, in perspective, one embodiment of the wheel unit according to the invention.

FIG. 2 is another perspective view of the wheel unit of FIG. 1, with the casing shown as transparent.

FIG. 3 is a perspective view of the casing of the wheel unit of FIG. 1 showing the deformable curved front portions, taken from the plastic material of the casing, before caulking.

FIG. 4 is a perspective view of the casing of the wheel unit of FIG. 1 showing the housing for receiving the valve base and the secondary deformable curved portions.

FIG. 5 is a perspective view of the metal insert comprising the curved front and rear portions.

FIG. 6 is a perspective view of the valve of the wheel unit of FIG. 1.

FIG. 7 is a perspective view of the arrangement of the metal insert of FIG. 5 and of the valve base of FIG. 6.

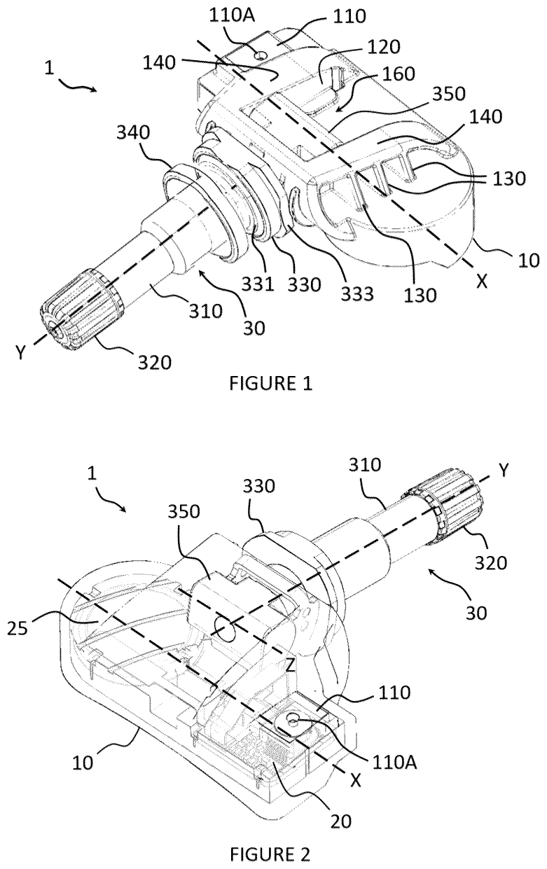

FIGS. 1 and 2 show an example of a wheel unit 1 according to an aspect of the invention. The wheel unit 1 is a valve sensor mounted through an orifice in the rim of the wheel (not shown), in a manner known per se.

The terms “front”, “rear”, “upper”, “lower”, “lateral” are defined according to the position of the sensor as shown in FIG. 1.

The wheel unit 1 comprises a casing 10, a measuring module 20 (visible through the casing 10 in transparency in FIG. 2), a power-supply battery 25 (also visible through the casing 10 in transparency in FIG. 2) and a valve 30.

The measuring module 20 is configured to measure the pressure of the air inside the wheel, in a manner known per se. The measuring module may, for example, also be configured to measure the temperature of the air inside the tire and the radial acceleration of the wheel unit 1 and therefore of the wheel itself.

As illustrated in FIG. 2, the casing 10 extends along a longitudinal axis X and defines an internal space in which the measuring module 20 is mounted (the casing 10 is illustrated in transparency in FIG. 2).

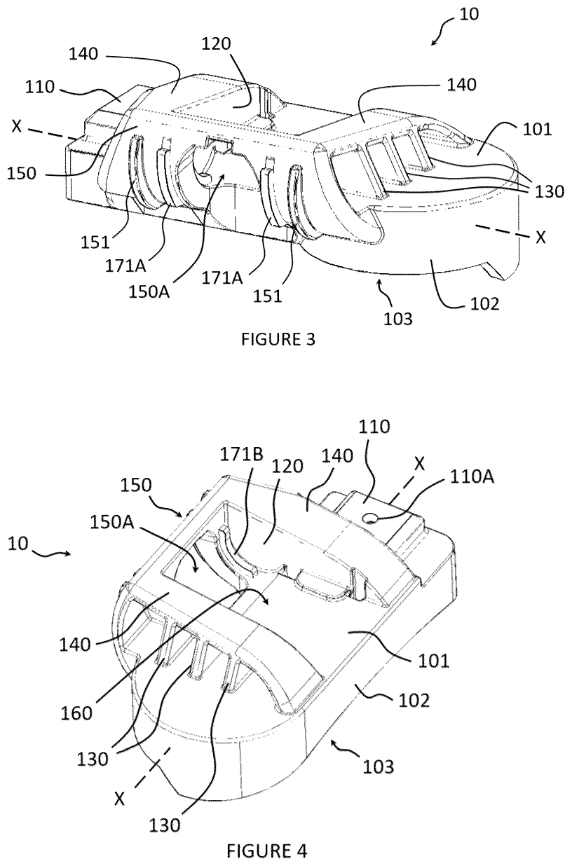

With reference to FIGS. 3 and 4, the casing 10 comprises an upper wall 101, a lateral wall 102 and a lower wall 103 made of the same material, for example by overmolding a plastic material.

The casing 10 comprises on its upper wall 101 a rectangular housing 110 in which there is formed a through-orifice 110A, visible in particular in FIG. 1, allowing the air to be conveyed to the measuring module 20.

With reference to FIGS. 1, 3 and 4, the casing 10 also comprises on its upper wall 101 two projection walls 120 projecting perpendicular to said upper wall 101 and parallel to each other. The casing 10 also comprises on its upper wall 101 reinforcements 130 projecting perpendicular to said upper wall 101 and parallel to each other.

The two projection walls 120 and the reinforcements 130 each support a curved upper portion 140.

The casing 10 comprises a convex front wall 150 extending upwards from the lateral wall 102. The front wall 150 connects the two projection walls 120 and the two curved upper portions 140 so as to form, with the upper wall 101, a housing 160 which is open in its upper part. An opening 150A is formed in the front wall 150 and opens out into the housing 160.

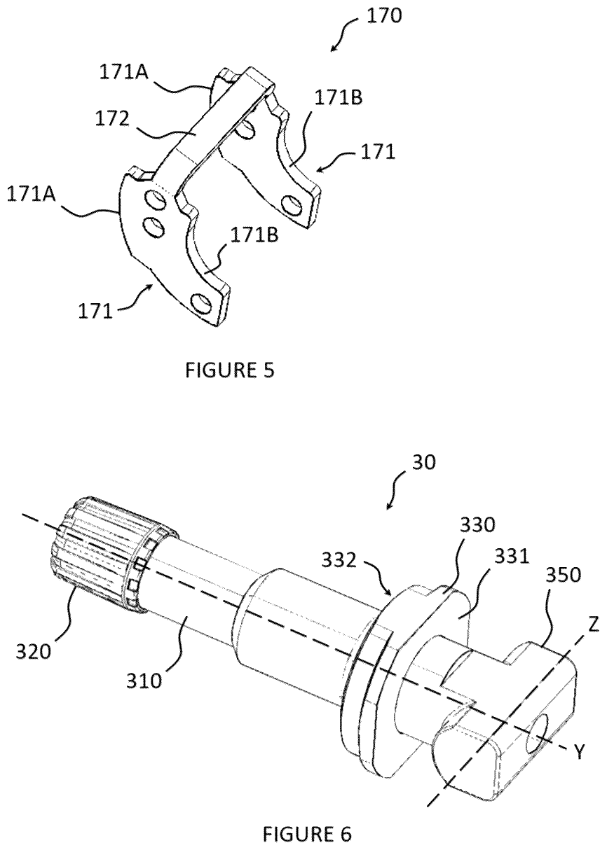

With reference to FIG. 5, the casing 10 comprises a metal insert 170 embedded in the material of the front wall 150, for example by molding or overmolding. The insert 170 comprises two wings 171 extending parallel to one another and connected by a connecting arm 172. Each wing 171 has a curved front portion 171A and a curved rear portion 171B.

As illustrated in FIG. 3, the curved front portions 171A project from the front face of the front wall 150.

As illustrated in FIG. 4, the curved rear portions 171B project from the rear face of the front wall 150.

The valve 30 comprises a valve body 310, a cap 320, a clamping ring 330, a union nut 340 and a valve base 350.

The valve body 310 is in the form of a tubular element and is configured to be positioned through an orifice in the rim of the wheel so as to protrude beyond the rim and allow the tire to be inflated from outside the wheel, in a manner known per se.

The valve body 310 extends along a longitudinal axis Y between a threaded free end, called the “air inlet” end, intended to be placed outside the rim and onto which the cap 320 is screwed, and a connected end, connected to the valve base 350.

The clamping ring 330 comprises a flat face 331 (FIG. 5), on the side facing the casing 10, and a front face 332, intended to come to bear against the interior face of the rim, thereby compressing a seal 331. Two ribs 151 extend from the front wall 150 and are formed from the material of said front wall 150 and prevent rotation of the clamping ring 330 once mounted against two flats 333 of the clamping ring 330 (FIG. 1).

The union nut 340 is intended to fix the valve 30 on the exterior face of the rim by cooperating with the clamping ring 330 located on the interior side of the rim.

The valve base 350 is connected to the valve body 310 by its connected end and extends perpendicular to said valve body 310 on either side of the connected end, along a longitudinal axis Z. The valve base 350 is mounted in the housing 160 with a clearance to pivot and so that the valve body 310 extends through the opening 150A. The two projection walls 120 prevent the valve base 350 from rotating about the longitudinal axis Y of the valve body 310.

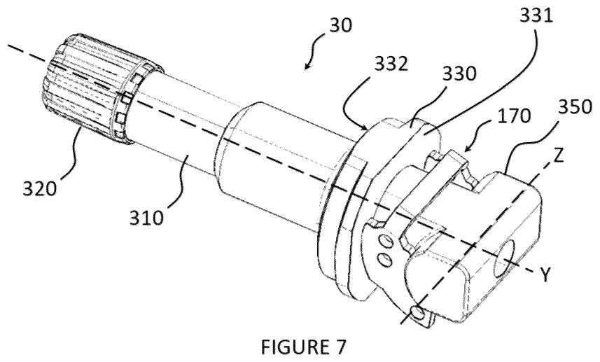

With reference to FIG. 7, when the valve 30 is clamped on the rim (not visible for clarity), the flat face 331 of the clamping ring 330 comes to caulk (i.e. to crush) the curved front portions 171A while the valve base 350 comes to rest against the curved rear portions 171B, ensuring optimum clamping.

### Example of Implementation

The wheel unit 1 takes the form of a one-piece element, i.e. the valve base 350 is mounted in the housing 160.

In order to mount the wheel unit 1 on the rim, the valve 30 is placed in the orifice in the rim until the clamping ring 330 comes to bear against the interior face of the rim. The position of the wheel unit 1 can be adjusted by pivoting the valve 30 about the longitudinal axis Z of the valve base 350, the domed front face of the valve base 350 bearing against the curved portions 171B of the insert 170 and the rear face of the front wall 150 of the casing 10 or, preferably, against only the curved projecting portions 171B, depending on the embodiment.

The union nut 340 is then screwed from outside the rim until it comes to bear against the outside face of the rim.

By tightening the union nut 340 against the external face of the rim, the flat face 331 of the clamping ring 330 comes to caulk (i.e. to crush) the curved front portions 171A while the valve base 350 comes to rest against the curved rear portions 171B, possibly likewise caulking these, thus ensuring reliable and optimum clamping.

The invention therefore makes it possible to fix the wheel unit 1 simply, effectively and quickly, while guaranteeing a high resistance to loading scenarios (clamping, crushing associated with the mounting of the tire on the rim, rotation of the wheel, vibrations, etc.) and optimum airtightness of the seal supported by the clamping ring.

1. A wheel unit for a motor vehicle wheel, said wheel unit comprising a casing made of a plastic material, a measuring module and a valve, said measuring module being mounted inside said casing and being configured to measure at least the air pressure inside the wheel, said valve (30) comprising:
a metal valve body configured to be positioned in an orifice in the wheel rim and extending between an air inlet free end fitted with a cap and a connected end,
a metal clamping ring placed around the valve body and configured to come to bear against the interior face of the rim via its front face, compressing a seal and comprising a rear face, opposite to the front face,
a union nut configured to be placed around the valve body and against the exterior face of the rim in order to fix the wheel unit on the rim by cooperating via the rim with the clamping ring, and
a metal valve base connected to the valve body by its connected end and extending on either side of the connected end along a longitudinal axis perpendicular to the longitudinal axis of the valve body, said valve base being mounted in a housing formed in the upper part of the casing with a clearance to pivot about the longitudinal axis of the valve base and such that the valve body extends out of the casing through an opening formed in a front wall of the casing, wherein the casing comprises an inbuilt metal insert integrated into said front wall, said insert comprising at least two curved portions projecting from the front wall and being configured to come into contact with the valve to lock said valve against the front wall while maintaining a clearance to prevent the clamping ring and/or the valve base from coming into contact with the plastic portions of the front wall.

2. The wheel unit as claimed in claim 1, wherein the insert comprises two deformable curved front portions projecting from the front face of the front wall of the casing and each configured to come to bear against the rear face of the clamping ring and to become caulked by said clamping ring when the union nut is tightened against the rim without the clamping ring coming into contact with the front wall of the casing.

3. The wheel unit as claimed in claim 1, wherein, with the valve base having a domed front face facing the rear face of the front wall, the insert comprises two curved rear portions projecting from the rear face of the front wall of the casing and which are shaped to conform to the domed front face of the valve base.

4. The wheel unit as claimed in claim 1, wherein the insert is of one piece.

5. The wheel unit as claimed in claim 1, wherein the insert comprises two wings connected by a connecting arm, each wing having a curved front portion.

6. The wheel unit as claimed in claim 1, wherein the insert is metal, for example made of steel.

7. The wheel unit as claimed in claim 1, wherein the rear face of the clamping ring is planar or curved.

8. The wheel unit as claimed in claim 1, wherein the clamping ring is metal.

9. A method of mounting a wheel unit as claimed in claim 1, said method comprising:
inserting the valve body into the valve orifice in the rim,
positioning the valve by pivoting about the longitudinal axis of the valve base,
fitting the union nut around the valve body,
tightening the union nut against the front face of the rim so that the rear face of the clamping ring caulks the curved front portions of the insert.

10. A wheel for a motor vehicle comprising a wheel unit as claimed in claim 1.

11. A motor vehicle comprising at least one wheel as claimed in claim 10.

12. The wheel unit as claimed in claim 2, wherein, with the valve base having a domed front face facing the rear face of the front wall, the insert comprises two curved rear portions projecting from the rear face of the front wall of the casing and which are shaped to conform to the domed front face of the valve base.
